(19) United States
(12) Patent Application Publication
(10) Pub. No.: US 2017/0295077 A1
(43) Pub. Date: Oct. 12, 2017

(54) OPTIMAL SERVICE PROVIDER SELECTION

(71) Applicant: Dell Software Inc., Round Rock, TX (US)

(72) Inventors: Karl Dyszynski, Lynnwood, WA (US); Steven C. Work, Bellingham, WA (US)

(21) Appl. No.: 15/217,801

(22) Filed: Jul. 22, 2016

Related U.S. Application Data
(60) Provisional application No. 62/321,658, filed on Apr. 12, 2016.

(51) Int. Cl. H04L 12/26

(52) U.S. Cl. CPC H04L 43/08; H04L 43/04; H04L 43/062

(57) ABSTRACT

A network routing server can be configured to receive client requests from multiple client devices and route the client requests to optimal service providers to service the request. To determine which service provider is optimal to service the client request, the network routing service can analyze multiple factors, such as geographic location of the client, geographic location of the service providers, and health metrics describing service quality of the various service providers. Health metrics can include Central Processing Unit (CPU) usage, bandwidth, memory usage, connectivity, service providers network status, network latency, user capacity saturation, etc. Based on an analysis of this data, the network routing service can determine the service provider that is best suited to service the client request and route the client request accordingly.

### CROSS REFERENCE TO RELATED APPLICATIONS

This application claims the priority benefit of U.S. provisional application No. 62/321,658, filed on Apr. 12, 2016, which is expressly incorporated by reference herein in its entirety.

### BACKGROUND OF THE INVENTION

### Field of the Invention

The present technology pertains to network routing services, and more specifically pertains to selecting an optimal service provider to service a request.

### Description of the Related Art

Network routing services are tasked with routing client requests to service providers that are capable of servicing the client requests. For example, a network routing service can receive a request from a client device, identify a set of service providers capable of servicing the client request and then route the client request to one of the identified service providers. Generally a network routing server will select a service provider from the set of service providers at random, round robin or based on geographic location. Current systems do not take into account the current health of the service providers or whether the selected service provider is the best suited to service the client request. Accordingly, improvements are needed.

### SUMMARY OF THE CLAIMED INVENTION

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for selecting an optimal service provider to service a client request. A network routing server can be configured to receive client requests from multiple client devices and route the client requests to optimal service providers to service the request. To determine which service provider is optimal to service the client request, the network routing service can analyze multiple factors, such as geographic location of the client, geographic location of the service providers, and health metrics describing service quality of the various service providers. Health metrics can include Central Processing Unit (CPU) usage, bandwidth, memory usage, connectivity, service provider's network status, network latency, user capacity saturation, etc. Based on an analysis of this data, the network routing service can determine the service provider that is best suited to service the client request and route the client request accordingly.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of computing devices and a network in accordance with the invention.

FIG. 2 illustrates an example method embodiment of selecting an optimal service provider to service a request.

FIGS. 3A and 3B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for selecting an optimal service provider to service a client request. A network routing server can be configured to receive client requests from multiple client devices and route the client requests to optimal service providers to service the request. To determine which service provider is optimal to service the client request, the network routing service can analyze multiple factors, such as geographic location of the client, geographic location of the service providers, and health metrics describing service quality of the various service providers. Health metrics can include Central Processing Unit (CPU) usage, bandwidth, memory usage, connectivity, service providers network status, network latency, user capacity saturation, etc. Based on an analysis of this data, the network routing service can determine the service provider that is best suited to service the client request and route the client request accordingly.

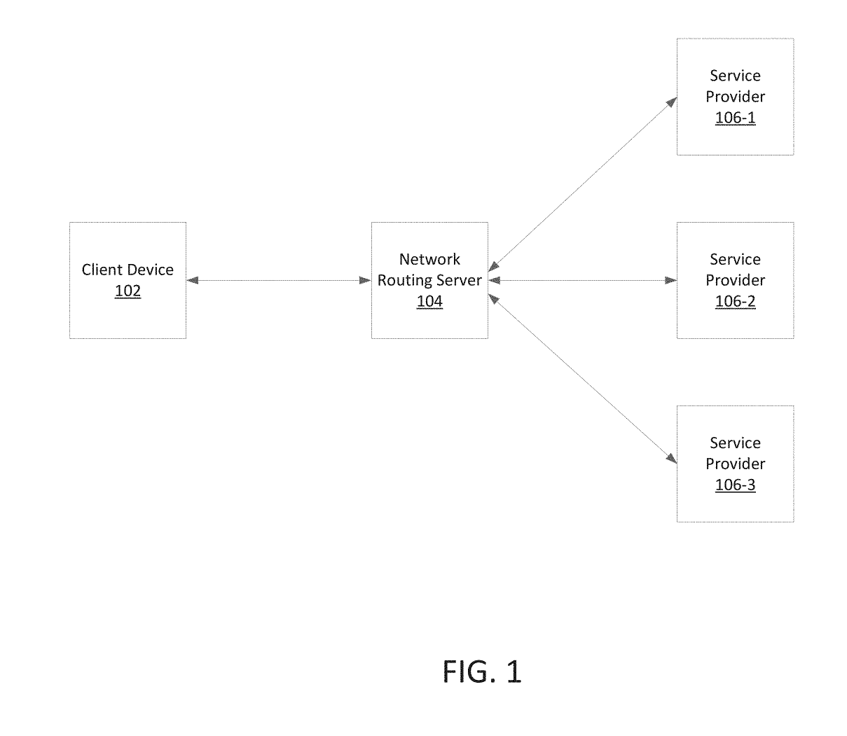

FIG. 1 illustrates an exemplary configuration 100 of computing devices and a network in accordance with the invention. The computing devices can be connected to a communication network and be configured to communicate with each other through use of the communication network. A communication network can be any type of network, including a local area network (“LAN”), such as an intranet, a wide area network (“WAN”), such as the internet, or any combination thereof. Further, a communication network can be a public network, a private network, or a combination thereof. A communication network can also be implemented using any number of communication links associated with one or more service providers, including one or more wired communication links, one or more wireless communication links, or any combination thereof. Additionally, a communication network can be configured to support the transmission of data formatted using any number of protocols.

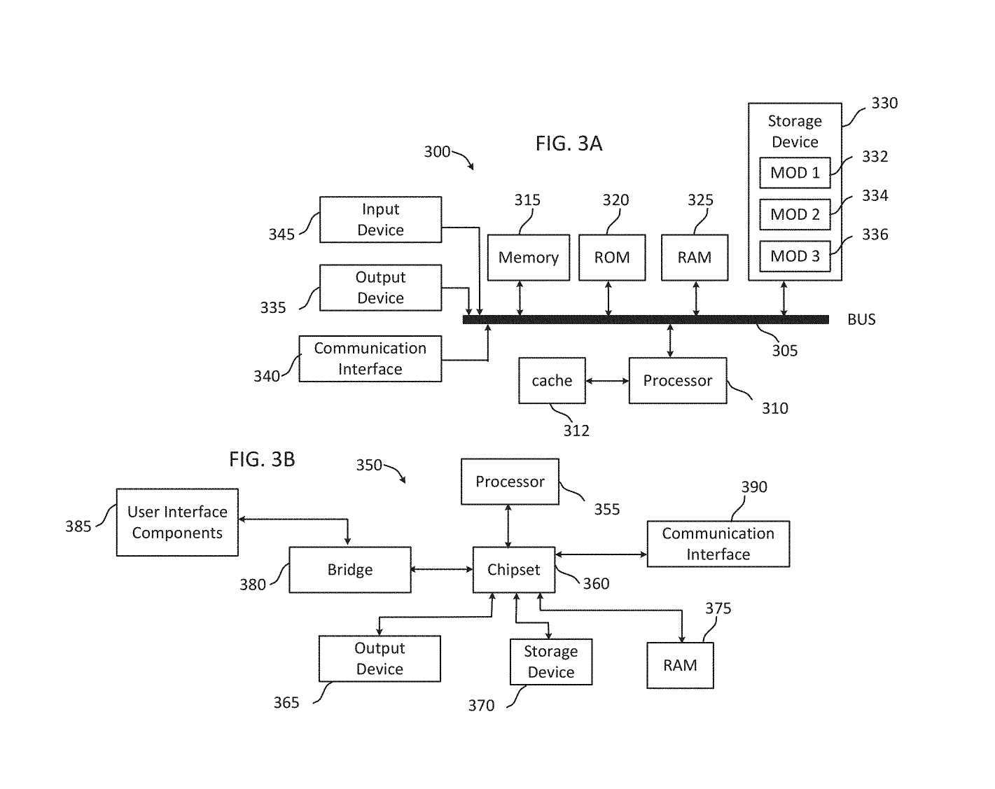

A computing device can be any type of general computing device capable of network communication with other computing devices. For example, a computing device can be a personal computing device such as a desktop or workstation, a business server, or a portable computing device, such as a laptop, smart phone, or a tablet PC. A computing device can include some or all of the features, components, and peripherals of computing device 300 of FIGS. 3A and 3B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As shown, system 100 includes five computing device: client device 102, network routing server 104 and service providers 1061, 1062 and 1063 (collectively 106). Although only five computing devices are shown in system 100, this is just one example and not meant to be limiting. System 100 can include any number client devices, network routing servers or service providers.

In system 100, a user can use client device 102 to transmit a request for a service provided by service providers 106. Service providers 106 can be computing servers that provide specified services or, alternatively, proxy access devices that forward client requests to an appropriate back end server that provides the requested services.

Network routing server 104 can be configured to receive a client request from client device 102 and route the client request to one of service providers 106 to provide the requested service. The client request can be a request for a service that can be provided by one or more of service providers 106. Network routing server 104 can determine which one of service providers 106 is the optimal service provider to service the client request and route the client request accordingly.

To determine which service provider 106 is optimal to service the client request, network routing server 104 can first identify a set of service providers 106 that are capable of servicing the client request. Network routing server 104 can maintain a table that identifies service providers 106 and the services that each service provider 106 is capable of providing. Network routing server 104 can use the table to identify the set of service providers 106 that are capable of providing the service requested by the client request.

Network routing server 104 can determine which service provider 106 from the identified set of service providers 106 is the optimal service provider to service the client request. To accomplish this, network routing server 104 can analyze multiple factors, such as the geographic location of client device 102, the geographic locations of service providers 106, and health metrics describing service quality of service providers 106. Health metrics can include Central Processing Unit (CPU) usage, bandwidth, memory usage, connectivity, service providers network status, network latency, user capacity saturation, etc.

In some embodiments, network routing server 104 can request the health metrics from the set of service provider 106 in response to receiving a client request. Alternatively, network routing server 104 can periodically receive the health metrics from service provider 106. For example, network routing server 104 can periodically query service providers 106 for health metrics. Service providers 106 can also periodically transmit or broadcast their health metrics to network routing server 104.

Network routing server 104 can use the health metrics gathered from the set of service providers 106, as well as the geographic locations of the set of service providers 106 and the geographic location of client device 102 to determine an optimal service provider to service the client request. For example, network routing server 104 can calculate health scores for each service provider from the set of service providers based on the health metrics received from the set of service providers. Network routing server 104 can then select the optimal service provider based on the health scores for each service provider. For example, network routing server 104 can select a service provider with the highest health score as the optimal service provider. Alternatively, network routing server 104 can select a service provider with the highest health score that is within a predetermined geographic distance from the geographic location of client device 102 as the optimal service provider.

In some embodiments, network routing server 104 can calculate a health score for a service provider based on individual scores calculated for individual health metrics gathered from the service provider, such as CPU usage, bandwidth, memory usage, connectivity, etc. For example, network routing server 104 can calculate a first score based on a first health metric received from a service provider, calculate a second score based on a second health metric received from the service provider, and then calculate a health score for the service provider based on the first score and the second score.

In some embodiments, network routing server 104 can apply varying weights to the individual scores to calculate the health score for a service provider. The weights can be used to prioritize health metrics considered to be of more importance in determining the health of a service provider. For example, a weight can be a multiplier applied to an individual score for a specific health metric. A multiplier greater than one can be used to provide additional value to the individual score for a health metric considered to be of greater importance in determining the health of a service provider. In contrast, a multiplier less than one can be used to provide less value to an individual score for a health metric considered to be of lesser importance in determining the health score for a service provider. When calculating the health score for a service provider, network routing server 104 can apply a first weight to a first score and a second weight to a second score. The network routing server can then use the weighted individual scores to calculate the health score for the service provider.

After determining the optimal service provider to service the request, network routing server 104 can route the client request to the selected service provider for servicing.

Although network routing server 104 is shown and described as a separate entity than service providers 106, this is only for ease of explanation and not meant to be limiting. In some embodiments, network routing server 104 can also be a service provider 106 (e.g., proxy access device or server capable of servicing the request). In this type of embodiment, network routing server 104 can determine whether to service the client request itself or route the client request to another service provider 106 for servicing. One or more service providers 106 can be configured to perform the functionality of network routing server 104 as described. For example, multiple service providers 106 can be configured to accept requests from public Domain Name Systems (DNS) and determine whether to service a client request themselves or route the client request to another service provider 106 that is best suited to service the request.

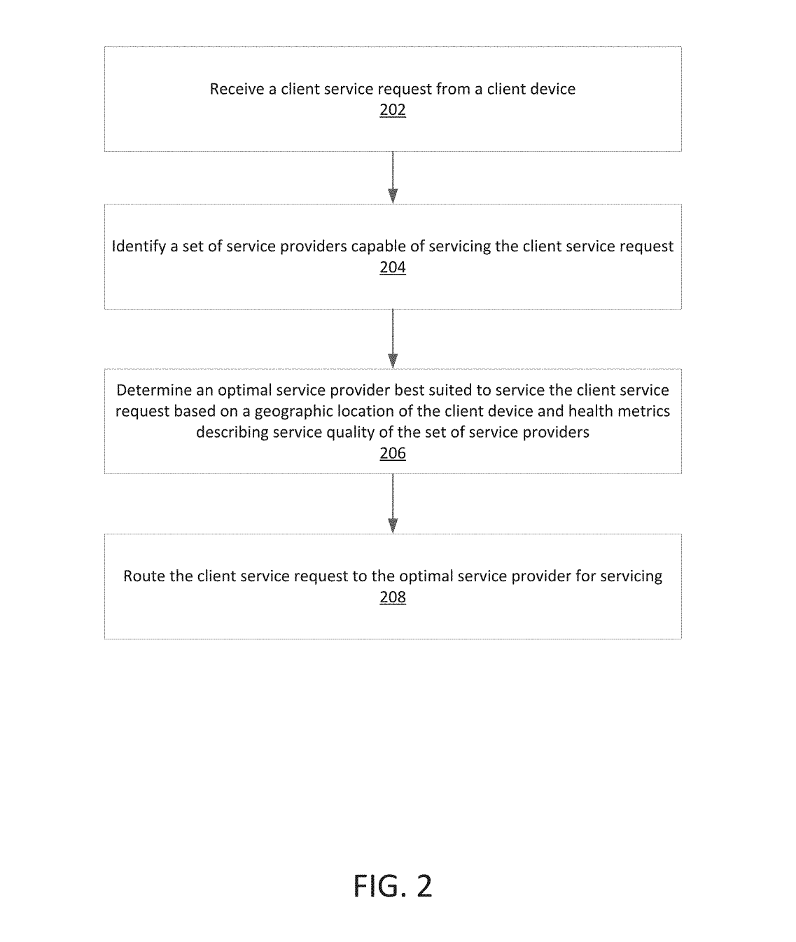

FIG. 2 illustrates an example method embodiment of selecting an optimal service provider to service a request. It should be understood that there can be additional, fewer, or alternative steps performed in similar or alternative orders, or in parallel, within the scope of the various embodiments unless otherwise stated.

At step 202, a network routing server can receive a client service request from a client device. The client service request can be a request for a service that can be provided by one or more service providers.

At step 204, the network routing server can identify a set of service providers capable of servicing the client service request. The network routing server can maintain a table identifying service providers as well the services that can be provided by the service providers. The network routing server can use the table to identify the set of service providers capable of servicing the client request.

At step 206, the network routing server can determine an optimal service provider best suited to service the client service request based on a geographic location of the client device and health metrics describing service quality of the set of service providers. The network routing server can receive the health metrics from the set of service providers. The health metrics can include at least one of Central Processing Unit (CPU) usage, bandwidth, memory usage, connectivity, service provider's network status, network latency or user capacity saturation.

To determine the optimal service provider, the network routing server can calculate health scores for each service provider from the set of service providers based on the health metrics received from the set of service providers. The network routing server can then select the optimal service provider based on the health scores for each service provider. For example, the network routing server can select a service provider with the highest health score as the optimal service provider.

In some embodiments, the network routing server can calculate a health score for a service provider based on individual scores calculated for individual health metrics gathered from the service provider, such as CPU usage, bandwidth, memory usage, connectivity, etc. For example, the network routing server can calculate a first score based on a first health metric received from a service provider, calculate a second score based on a second health metric received from the service provider, and then calculate a health score for the service provider based on the first score and the second score.

In some embodiments, the network routing server can also apply varying weights to the individual scores to calculate the health score for a service provider. The weights can be used to prioritize health metrics considered to be of more importance in determining the health of a service provider. For example, a weight can be a multiplier applied to an individual score for a specific health metric. A multiplier greater than one can be used to provide additional value to the individual score for a health metric considered to be of greater importance in determining the health of a service provider. In contrast, a multiplier less than one can be used to provide less value to an individual score for a health metric considered to be of lesser importance in determining the health score for a service provider. When calculating the health score for a service provider, the network routing server can apply a first weight to a first score and a second weight to a second score. The network routing server can then use the weighted individual scores to calculate the health score for the service provider.

At step 208, the network routing server can route the client service request to the optimal service provider for servicing.

FIGS. 3A and 3B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 3A illustrates a conventional system bus computing system architecture 300 wherein the components of the system are in electrical communication with each other using a bus 305. Exemplary system 300 includes a processing unit (CPU or processor) 310 and a system bus 305 that couples various system components including the system memory 315, such as read only memory (ROM) 320 and random access memory (RAM) 325, to the processor 310. The system 300 can include a cache of high-speed memory connected directly with, in close proximity to, or integrated as part of the processor 310. The system 300 can copy data from the memory 315 and/or the storage device 330 to the cache 312 for quick access by the processor 310. In this way, the cache can provide a performance boost that avoids processor 310 delays while waiting for data. These and other modules can control or be configured to control the processor 310 to perform various actions. Other system memory 315 may be available for use as well. The memory 315 can include multiple different types of memory with different performance characteristics. The processor 310 can include any general purpose processor and a hardware module or software module, such as module 1 332, module 2 334, and module 3 336 stored in storage device 330, configured to control the processor 310 as well as a special-purpose processor where software instructions are incorporated into the actual processor design. The processor 310 may essentially be a completely self-contained computing system, containing multiple cores or processors, a bus, memory controller, cache, etc. A multi-core processor may be symmetric or asymmetric.

To enable user interaction with the computing device 300, an input device 345 can represent any number of input mechanisms, such as a microphone for speech, a touch-sensitive screen for gesture or graphical input, keyboard, mouse, motion input, speech and so forth. An output device 335 can also be one or more of a number of output mechanisms known to those of skill in the art. In some instances, multimodal systems can enable a user to provide multiple types of input to communicate with the computing device 300. The communications interface 340 can generally govern and manage the user input and system output. There is no restriction on operating on any particular hardware arrangement and therefore the basic features here may easily be substituted for improved hardware or firmware arrangements as they are developed.

Storage device 330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 325, read only memory (ROM) 320, and hybrids thereof.

The storage device 330 can include software modules 332, 334, 336 for controlling the processor 310. Other hardware or software modules are contemplated. The storage device 330 can be connected to the system bus 305. In one aspect, a hardware module that performs a particular function can include the software component stored in a computer-readable medium in connection with the necessary hardware components, such as the processor 310, bus 305, display 335, and so forth, to carry out the function.

FIG. 3B illustrates a computer system 350 having a chipset architecture that can be used in executing the described method and generating and displaying a graphical user interface (GUI). Computer system 350 is an example of computer hardware, software, and firmware that can be used to implement the disclosed technology. System 350 can include a processor 355, representative of any number of physically and/or logically distinct resources capable of executing software, firmware, and hardware configured to perform identified computations. Processor 355 can communicate with a chipset 360 that can control input to and output from processor 355. In this example, chipset 360 outputs information to output 365, such as a display, and can read and write information to storage device 370, which can include magnetic media, and solid state media, for example. Chipset 360 can also read data from and write data to RAM 375. A bridge 380 for interfacing with a variety of user interface components 385 can be provided for interfacing with chipset 360. Such user interface components 385 can include a keyboard, a microphone, touch detection and processing circuitry, a pointing device, such as a mouse, and so on. In general, inputs to system 350 can come from any of a variety of sources, machine generated and/or human generated.

Chipset 360 can also interface with one or more communication interfaces 390 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 355 analyzing data stored in storage 370 or 375. Further, the machine can receive inputs from a user via user interface components 385 and execute appropriate functions, such as browsing functions by interpreting these inputs using processor 355.

It can be appreciated that exemplary systems 300 and 350 can have more than one processor 310 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method for routing client service requests comprising:
receiving a client service request from a client device;
identifying a set of service providers capable of servicing the client service request;
determining an optimal service provider best suited to service the client service request based on a geographic location of the client device and health metrics describing service quality of the set of service providers; and
routing the client service request to the optimal service provider for servicing.

2. The method of claim 1, wherein the health metrics include at least one of Central Processing Unit (CPU) usage, bandwidth, memory usage, connectivity, service provider's network status, network latency or user capacity saturation.

3. The method of claim 1, further comprising receiving the health metrics from the set of service providers.

4. The method of claim 3, wherein determining the optimal service provider comprises:
calculating health scores for each service provider from the set of service providers based on the health metrics received from the set of service providers; and
selecting the optimal service provider based on the health scores for each service provider.

5. The method of claim 4, wherein selecting the optimal service provider based on the health scores for each service provider comprises selecting a service provider with the highest health score as the optimal service provider.

6. The method of claim 4, wherein calculating health scores for each service provider comprises:
calculating a first score based on a first health metric received from a first service provider;
calculating a second score based on a second health metric received from the first service provider; and
calculating a health score for the first service provider based on the first score and the second score.

7. The method of claim 5, wherein calculating the health score for the first service provider further comprises applying a first weight to the first score and a second weight to the second score.

8. A network routing server comprising:
one or more computer processors; and
a memory storing instructions that, when executed by the one or more computer processors, cause the network routing server to:
receive a client service request from a client device;
identify a set of service providers capable of servicing the client service request;
determine an optimal service provider best suited to service the client service request based on a geographic location of the client device and health metrics describing service quality of the set of service providers; and
route the client service request to the optimal service provider for servicing.

9. The network routing server of claim 8, wherein the health metrics include at least one of Central Processing Unit (CPU) usage, bandwidth, memory usage, connectivity, service provider's network status, network latency or user capacity saturation.

10. The network routing server of claim 8, wherein the instructions further cause the network routing server to receive the health metrics from the set of service providers.

11. The network routing server of claim 10, wherein determining the optimal service provider comprises:
calculating health scores for each service provider from the set of service providers based on the health metrics received from the set of service providers; and
selecting the optimal service provider based on the health scores for each service provider.

12. The network routing server of claim 11, wherein selecting the optimal service provider based on the health scores for each service provider comprises selecting a service provider with the highest health score as the optimal service provider.

13. The network routing server of claim 11, wherein calculating health scores for each service provider comprises:
calculating a first score based on a first health metric received from a first service provider;
calculating a second score based on a second health metric received from the first service provider; and
calculating a health score for the first service provider based on the first score and the second score.

14. The network routing server of claim 13, wherein calculating the health score for the first service provider further comprises applying a first weight to the first score and a second weight to the second score.

15. A non-transitory computer-readable medium storing instructions that, when executed by a network routing server, cause the network routing server to:
receive a client service request from a client device;
identify a set of service providers capable of servicing the client service request;
determine an optimal service provider best suited to service the client service request based on a geographic location of the client device and health metrics describing service quality of the set of service providers; and
route the client service request to the optimal service provider for servicing.

16. The non-transitory computer-readable medium of claim 15, wherein the health metrics include at least one of Central Processing Unit (CPU) usage, bandwidth, memory usage, connectivity, service provider's network status, network latency or user capacity saturation.

17. The non-transitory computer-readable medium of claim 15, wherein the instructions further cause the network routing server to receive the health metrics from the set of service providers.

18. The non-transitory computer-readable medium of claim 17, wherein determining the optimal service provider comprises:
calculating health scores for each service provider from the set of service providers based on the health metrics received from the set of service providers; and
selecting the optimal service provider based on the health scores for each service provider.

19. The non-transitory computer-readable medium of claim 18, wherein selecting the optimal service provider based on the health scores for each service provider comprises selecting a service provider with the highest health score as the optimal service provider.

20. The non-transitory computer-readable medium of claim 18, wherein calculating health scores for each service provider comprises:
calculating a first score based on a first health metric received from a first service provider;
calculating a second score based on a second health metric received from the first service provider; and
calculating a health score for the first service provider based on the first score and the second score.
